(19) United States
(12) Patent Application Publication
(10) Pub. No.: US 2025/0014359 A1
(43) Pub. Date: Jan. 9, 2025

(54) ROAD BOUNDARY DETECTION METHOD AND APPARATUS, AND ELECTRONIC DEVICE, STORAGE MEDIUM AND COMPUTER PROGRAM PRODUCT

(71) Applicants: SENSETIME GROUP LIMITED, Hong Kong (CN); HONDA MOTOR CO., LTD., Tokyo (JP)

(72) Inventors: Chenguang LI, Hong Kong (CN); Guangliang CHENG, Hong Kong (CN); Jianping SHI, Hong Kong (CN); Tokitomo ARIYOSHI, Tokyo (JP); Umiaki MATSUBARA, Tokyo (JP); Yuji YASUI, Tokyo (JP); Yusuke NAKAZATO, Hong Kong (CN); Tatsuya SUZUKI, Hong Kong (CN); Nobuaki AMANO, Hong Kong (CN)

(21) Appl. No.: 18/892,714

(22) Filed: Sep. 23, 2024

Related U.S. Application Data
(63) Continuation of application No. PCT/CN2022/129043, filed on Nov. 1, 2022.

(30) Foreign Application Priority Data
Mar. 24, 2022 (CN) 202210303727.1

(51) Int. Cl. G06V 20/56; B60W 60/00; G06V 20/58

(52) U.S. Cl. CPC G06V 20/588; B60W 60/001; G06V 20/582

(57) ABSTRACT

A road boundary detection method and apparatus, and an electronic device, a storage medium and a computer program product are provided. The method includes that: a road image, which is collected by an image collection device arranged on a vehicle is identified, and then a plurality of road boundaries from the road image is determined; and a road boundary inside which the vehicle can travel is selected from the plurality of road boundaries.

### CROSS-REFERENCE TO RELATED APPLICATIONS

This is a continuation application of International Patent Application No. PCT/CN2022/129043, filed on Nov. 1, 2022, which is based on and claims the benefit of priority of the Chinese Patent Application No. 202210303727.1, filed on Mar. 24, 2022, and entitled “Road boundary detection method and device, electronic equipment and storage medium”. The disclosures of International Patent Application No. PCT/CN2022/129043 and Chinese Patent Application No. 202210303727.1 are incorporated by reference herein in their entireties.

### BACKGROUND

In the process of turning at an intersection, a self-driving vehicle based on camera perception not only needs to detect the position of the road boundary, but also needs to detect the road boundary into which the vehicle can enter, so as to provide sufficient basis for the decision-making of the self-driving vehicle in turning at an intersection. Currently, for the scene involving road boundaries, it is impossible to determine the road boundary into which the vehicle can enter.

### SUMMARY

In order to solve the technical problem existing in the related art, the embodiments of the present disclosure provide a method and apparatus for road boundary detection, an electronic device, a storage medium and a computer program product.

In order to achieve the above purpose, the technical solutions of embodiments of the disclosure are achieved as follows.

The disclosure relates to but is not limited to the field of computer vision technology, and specifically relates to a method and apparatus for road boundary detection, an electronic device, a storage medium and a computer program product.

The embodiment of the disclosure provides a method for road boundary detection, the method includes the following operations.

A road image acquired by an image acquisition device arranged on a vehicle is identified, and multiple road boundaries in the road image is determined.

A road boundary into which the vehicle is able to enter is selected from the multiple road boundaries.

The embodiment of the disclosure further provides an apparatus for road boundary detection, the apparatus includes a processor.

The processor is configured to identify a road image acquired by an image acquisition device arranged on a vehicle, and determine multiple road boundaries in the road image.

The processor is further configured to select a road boundary into which the vehicle is able to enter from the multiple road boundaries.

The embodiment of the disclosure further provides a non-transitory computer readable storage medium, having stored thereon a computer program that, when executed by a processor, implements a method for road boundary detection, the method includes the following operations.

A road image acquired by an image acquisition device arranged on a vehicle is identified, and multiple road boundaries in the road image is determined.

A road boundary into which the vehicle is able to enter is selected from the multiple road boundaries.

It should be understood that the above general description and the following detailed description are only exemplary and explanatory, and are not intended to limit the disclosure.

### BRIEF DESCRIPTION OF THE DRAWINGS

In order to explain the technical solutions of embodiments of the disclosure more clearly, the drawings required for use in the embodiments of the disclosure will be illustrated in the following.

The drawings herein are incorporated into the specification and form a part of the specification, these drawings illustrate embodiments in accordance with the disclosure and are used to illustrate the technical solutions of the disclosure together with the specification.

FIG. 1A is a schematic diagram of road boundaries in a method for road boundary detection according to an embodiment of the disclosure;

FIG. 1B is a schematic diagram of road boundaries into which the vehicle is able to enter in the method for road boundary detection according to an embodiment of the disclosure;

FIG. 2A is a first schematic diagram of an application scenario according to an embodiment of the disclosure;

FIG. 2B is a second schematic diagram of an application scenario according to an embodiment of the disclosure;

FIG. 3 is a first schematic flowchart of the method for road boundary detection according to an embodiment of the disclosure;

FIG. 4A is a first schematic diagram of the scenario of the ego lane in the method for road boundary detection according to an embodiment of the disclosure;

FIG. 4B is a second schematic diagram of the scenario of the ego lane in the method for road boundary detection according to an embodiment of the disclosure;

FIG. 5 is a first schematic diagram of the composition structure of an apparatus for road boundary detection according to an embodiment of the disclosure;

FIG. 6 is a second schematic diagram of the composition structure of the apparatus for road boundary detection according to an embodiment of the disclosure;

FIG. 7 is a third schematic diagram of the composition structure of the apparatus for road boundary detection according to an embodiment of the disclosure; and

FIG. 8 is a schematic diagram of the hardware composition structure of an electronic device according to an embodiment of the disclosure.

### DETAILED DESCRIPTION

The disclosure will be described in further detail below with reference to the accompanying drawings and the specific embodiments.

Before explaining the solution of the road boundary detection in embodiments of the disclosure, some concepts are briefly described firstly

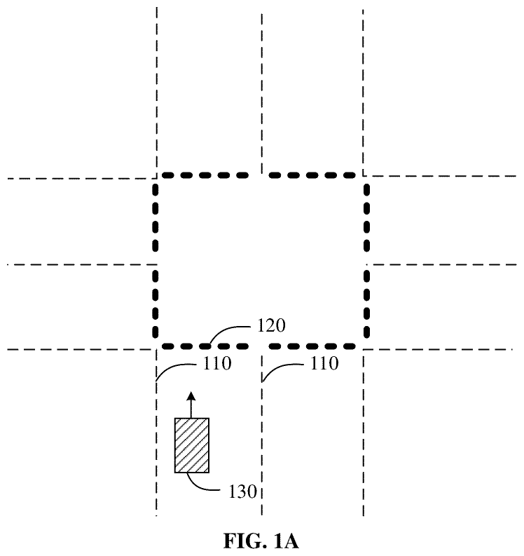

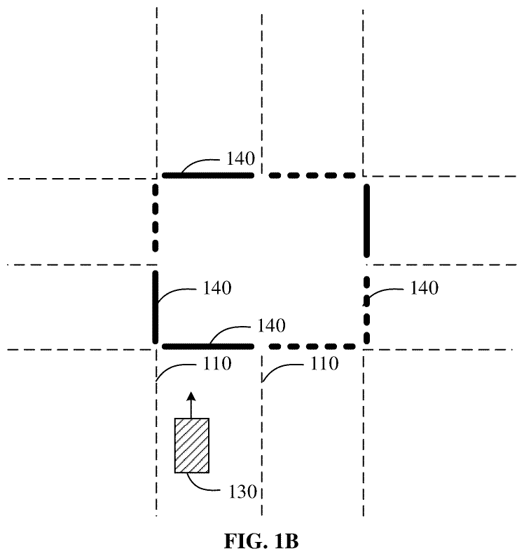

FIG. 1A and FIG. 1B are schematic diagrams of road boundaries and road boundaries into which the vehicle is able to enter in the method for road boundary detection according to embodiments of the disclosure, respectively. In addition to the boundaries 110 on both sides of the lane where the vehicle 130 is located, the road boundary also includes boundaries 120 perpendicular to both sides of the lane, as shown in FIG. 1A, these boundaries are collectively referred to as road boundaries in the following embodiments. In the intersection shown in the scene, eight road boundaries are visible.

As shown in FIG. 1B, if the lane is a two-way lane, the road boundary corresponding to the driving direction of the vehicle is the road boundary into which the vehicle is able to enter. Assuming that the vehicle 130 drives on the left side, for two road boundaries 120 in each direction, all road boundaries on the left side are the road boundaries 140 into which the vehicle is able to enter.

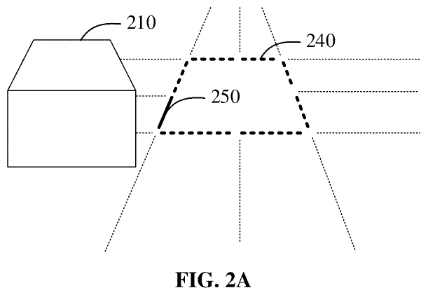

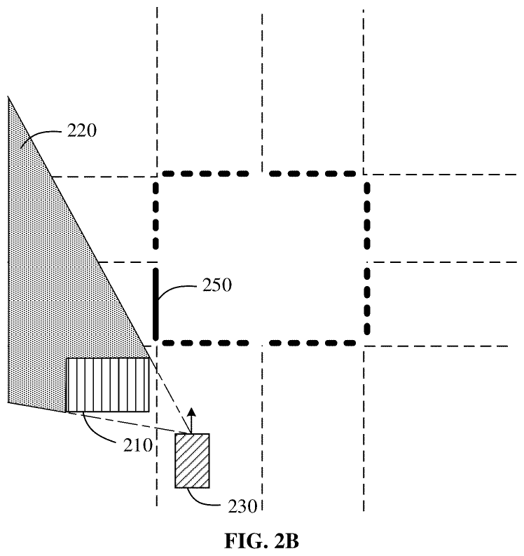

FIG. 2A is a first schematic diagram of an application scenario according to an embodiment of the disclosure. As shown in FIG. 2A, assuming that in the intersection scene shown in FIG. 1A and FIG. 1B, there is an obstacle 210 at the southwest corner of the intersection (the upper, lower, left, and right sides of the image correspond to north, south, west, and cast, respectively). Generally, the obstacle 210 will block the view of the vehicle driving from south to north. FIG. 2B is a second schematic diagram of an application scenario according to an embodiment of the disclosure. As shown in FIG. 2B, the driver or sensor in the vehicle 230 cannot obtain information of a partial area blocked by the obstacle 210, the partial area may be referred to as an unknown area 220. Among the eight road boundaries present in the scene, the road boundaries that are blocked by the obstacle or that cannot be perceived by the driver or sensor in the vehicle 230 due to other reasons (such as being too far away, etc.) are called invisible road boundaries 250 (depicted as thick solid line in FIG. 2A and FIG. 2B), and the road boundaries that can be perceived by the driver or sensor in the vehicle 230 are visible road boundaries 240 (depicted as thick dotted lines in FIG. 2A).

In order to solve the above problem, in embodiments of the disclosure, a road image acquired by an image acquisition device arranged on a vehicle is identified, multiple road boundaries in the road image are determined, and a road boundary into which the vehicle is able to enter is selected from the multiple road boundaries, so that the road boundaries (especially the invisible road boundaries) can be identified, and the determination for the road boundary into which the vehicle is able to enter can be achieved.

It should be noted that the terms “including”, “comprising” or any other variation thereof in embodiments of the disclosure are intended to encompass non-exclusive inclusion, so that a method or an apparatus that includes a series of elements not only includes those elements explicitly descried, but also includes other elements not explicitly listed, or also includes elements that are inherent to the implementation of the method or the apparatus. Without further limitation, the elements defined by the statement “include a . . . ” does not exclude the presence of other relevant elements (such as the operations in the method or the parts in the apparatus, such parts may be partial circuits, partial processors, partial programs or softwares, etc.) in the method or the apparatus that includes those elements.

For example, the method for road boundary detection provided in the embodiments of the disclosure includes a series of operations, but the method for road boundary detection provided in the embodiments of the disclosures is not limited to the operations descried. Similarly, the apparatus for road boundary detection provided in the embodiments of the disclosure includes a series of modules, but the apparatus for road boundary detection provided in the embodiments of the disclosures is not limited to the modules descried, and may further include modules required to set for acquiring relevant information or processing based on information.

The term “and/or” herein is merely an association relationship that describes associated objects, indicating that there are three relationships, for example, A and/or B may indicate three situations: only A exist, both A and B exist, and only B exist. In addition, the term “at least one of” herein indicates any one of the multiple or any combination of at least two of the multiple, for example, including at least one of A, B, or C may indicate including any one or more elements selected from a set formed by A, B, and C.

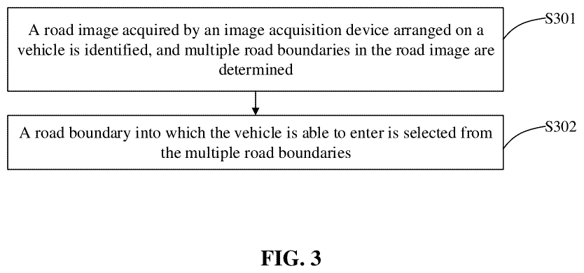

The embodiment of the disclosure provides a method for road boundary detection. FIG. 3 is a first schematic flowchart of the method for road boundary detection according to an embodiment of the disclosure. As shown in FIG. 3, the method includes the following operations.

At operation S301: a road image acquired by an image acquisition device arranged on a vehicle is identified, and multiple road boundaries in the road image are determined.

At operation S302: a road boundary into which the vehicle is able to enter is selected from the multiple road boundaries.

The method for road boundary detection in embodiments of the disclosure is applied to an electronic device, which may be a vehicle-mounted device, a cloud platform or other computer device. Exemplary, the vehicle-mounted device may be a thin client, a thick client, a microprocessor-based system, a minicomputer system, or the like installed on a vehicle. The cloud platform may be a distributed cloud computing technology environment including a minicomputer system or a large-scale computer system, or the like.

In embodiments of the disclosure, the vehicle-mounted device may be communicatively connected to sensors, positioning device and the like of the vehicle. The vehicle-mounted device may obtain data acquired by the sensors of the vehicle and geographical location information reported by the positioning device through the communication connection. Exemplary, the sensors of the vehicle may be at least one of: millimeter-wave radar, laser radar, camera and the like. The positioning device may be a device that provides positioning services based on at least one of the following positioning systems: global positioning system (GPS), BeiDou satellite navigation system or Galileo satellite navigation system.

In some embodiments, the vehicle-mounted device may be an advanced driving assistant system (ADAS) provided on the vehicle. The ADAS may obtain real-time position information of the vehicle from the positioning device of the vehicle, and/or the ADAS may obtain image data, radar data, and the like that represents the environment information around the vehicle from the sensors of the vehicle. The ADAS may transmit the vehicle driving data including the real-time position information of the vehicle to the cloud platform, so that the cloud platform may receive the real-time position information of the vehicle and/or the image data, the radar data, and the like that represents the environment information around the vehicle.

In embodiments of the disclosure, a road image is obtained by an image acquisition device (that is, the above described sensors, such as a camera) arranged on a vehicle, and the image acquisition device acquires a road image or an environmental image around the vehicle in real time as the vehicle moves. Further, by detecting and identifying the road image, multiple road boundaries related to the vehicle in the road image are determined, and then a road boundary into which the vehicle is able to enter is selected from the multiple road boundaries.

By adopting the technical solutions of embodiments of the disclosure, the electronic device can determine the road boundary into which the vehicle is able to enter on the basis of the identified road boundaries. Especially, in the scene that the road boundaries are invisible, the road boundary into which the vehicle is able to enter can be determined, so as to provide sufficient basis for the decision-making of the vehicle in turning at an intersection.

In some embodiments of the disclosure, the operation of determining multiple road boundaries in the road image includes that: multiple lanes in the road image are detected, and the multiple road boundaries are determined by connecting ends of the multiple lanes.

In embodiments of the disclosure, the multiple lanes in the road image may be detected through a first network, that is, the multiple lane markings in the road image may be detected. Exemplary, the road image is processed through the first network to obtain lane markings in the road image. Then, multiple road boundaries related to the vehicle are obtained by connecting the end edges of the lane markings.

In other implementations, other image detection schemes may also be adopted to detect multiple lanes in the road image. Exemplary, the road image is grayed firstly, and the lane edge in the road image after grayed is detected, for example, an edge detection operator is adopted to perform edge detection. Then, the processed image is binarized to obtain the lane markings in the road image.

In other embodiments, the operation of determining the multiple road boundaries in the road image includes that: a freespace in the road image is detected, and the multiple road boundaries in the road image are determined based on contour lines of the freespace.

In embodiments of the disclosure, the freespace in the road image may be detected through a second network. The freespace, also known as a passable area, represents an area where the vehicle can drive or an area where the vehicle is able to drive. In the road image, in addition to the current vehicle, the road image usually includes other vehicles, pedestrians, trees, road edges, etc. The areas where the above-mentioned other vehicles, pedestrians, trees, and road edges are located are all areas where the current vehicle cannot drive. Therefore, the road image is processed through the second network, and the areas where other vehicles, pedestrians, trees, and road edges are located in the road image are removed, so as to obtain the freespace of the vehicle.

In further embodiments, the operation of determining the multiple road boundaries in the road image includes that: multiple road boundaries related to the vehicle are determined by using a third network to detect the road image.

In embodiments of the disclosure, the road image may be processed by using the pre-trained third network to obtain the multiple road boundaries related to the vehicle.

The first network, the second network, and the third network mentioned above may all be deep neural networks (DNN).

In some embodiments of the disclosure, the operation of selecting the road boundary into which the vehicle is able to enter from the multiple road boundaries includes that: an ego lane where the vehicle is located is determined based on the road image; and the road boundary into which the vehicle is able to enter is determined from the multiple road boundaries based on the ego lane where the vehicle is located.

In embodiments of the disclosure, after determining the road boundaries as shown in FIG. 1A, the ego lane where the vehicle is located may be further determined, and the road boundary into which the vehicle is able to enter is determined from the multiple road boundaries based on the ego lane where the vehicle is located.

The road boundaries corresponding to the driving direction of the vehicle are the road boundaries into which the vehicle is able to enter. Exemplary, as shown in FIG. 1B, in a case that the vehicle drives on the left side, the road boundaries in the left lane are the road boundaries into which the vehicle can drive, and the road boundaries in the right lane are the road boundaries into which the vehicle cannot drive. Correspondingly, in a case that the vehicle drives on the right side, the road boundaries in the right lane are the road boundaries into which the vehicle can drive, and the road boundaries in the left lane are the road boundaries into which the vehicle cannot drive. The above “left” and “right” are relative. In the case that a person faces the road boundaries shown in FIG. 1A in the driving direction of the vehicle, for the two lanes divided by the solid lines between the lanes, the lane on the left is called the left lane, and the lane on the right is called the right lane.

In some embodiments, the operation of determining the ego lane where the vehicle is located based on the road image includes that: traffic markings in the road image are identified; and the ego lane where the vehicle is located is determined based on the traffic signs.

In other embodiments, the operation of determining the ego lane where the vehicle is located based on the road image includes that: a driving direction of other vehicle in the road image is identified; and the ego lane where the vehicle is located is determined based on the driving direction of the other vehicle.

In embodiments of the disclosure, the electronic device may determine the ego lane where the vehicle is located based on the identified traffic signs and/or the driving direction of the other vehicle.

Exemplary, the traffic signs include at least one of: indications on traffic signboards, road markings, and the like. The traffic signboards are used for indicating graphic symbols of traffic regulations and road information, and are usually arranged at intersections or road edges for managing traffic and indicating driving directions to ensure smooth traffic and safe driving. The road markings are for example the line markings on the road (e.g., white solid lines, white dotted lines, yellow solid lines, double yellow solid lines, etc.), the markings that identify the road attributes on the road (e.g., straight markings, turning markings, speed limit markings, bus-only markings, etc., that is, markings are manually painted on the road).

In embodiments of the disclosure, the electronic device may determine the ego lane where the vehicle is located through the driving direction of the other vehicle detected in the road image. The electronic device may further determine the ego lane where the vehicle is located through the traffic signs detected in the road image. The electronic device may further determine the ego lane where the vehicle is located through the traffic signs and the driving direction of the other vehicle detected in the road image.

In some embodiments, the operation of determining the ego lane where the vehicle is located based on the traffic signs includes that: in a case that the traffic signs indicate that the lane where the vehicle is located is not a one-way lane, and the traffic signs include the designated road markings, the ego lane where the vehicle is located is determined based on designated road markings.

In embodiments of the disclosure, the designated road markings are used to indicate traffic flows driving in the same direction or to separate traffic flows driving in the opposite direction. Exemplary, the designated road markings are for example solid lines (e.g., yellow solid lines, double yellow solid lines, etc.), dotted lines (e.g., white dotted lines).

In other embodiments, the operation of determining the ego lane where the vehicle is located based on the driving direction of the other vehicle includes that: in a case that the driving direction of the other vehicle is opposite to a driving direction of the vehicle, the ego lane where the vehicle is located is determined based on the lane where the other vehicle is located.

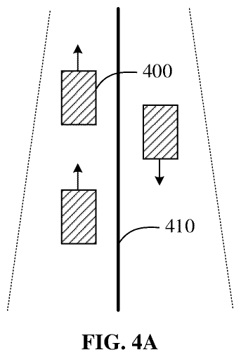

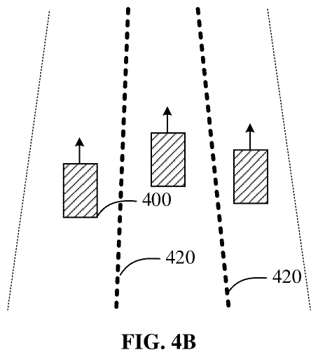

As an example, FIG. 4A is a first schematic diagram of the scenario of the ego lane in the method for road boundary detection according to an embodiment of the disclosure. As shown in FIG. 4A, upon identifying the traffic signs and determining that the lane is not a one-way lane, and if a solid line (such as the thick solid line 410 in FIG. 4A) is identified in the road image and the vehicle 400 is driving on the left side, it is determined that the lane on the left side of the solid line is the ego lane. In this example, the thick solid line 410 is the designated road marking described above.

As another example, FIG. 4B is a second schematic diagram of the scenario of the ego lane in the method for road boundary detection according to an embodiment of the disclosure. As shown in FIG. 4B, if the dotted lines (such as the thick dotted lines 420 in FIG. 4B) are identified by identifying the road image, and the vehicle 400 is driving on the left side, it is determined that the lane on the left side of the dotted lines may be the ego lane. The ego lane may be further determined based on other traffic signs or by the identification result of the road image.

As yet another example, if it is identified, by identifying the road image, that there are other vehicle in the opposite direction to the driving direction of the current vehicle in the road image, it is determined that the lane where the other vehicle is located is not the ego lane of the vehicle. Furthermore, the ego lane of the vehicle is obtained by excluding the lane where other vehicle (which is driving in the opposite direction to the current vehicle) is located from the lanes. In other embodiments, after determining that the lane where other vehicle is located is not the ego lane of the vehicle, the road boundaries corresponding to the lane where other vehicle is located may be further determined, and the road boundaries corresponding to the lane where other vehicle (which is driving in the opposite direction to the current vehicle) is located may be excluded from the multiple road boundaries determined at operation S301, so as to obtain the road boundary into which the vehicle is able to enter.

In some embodiments of the disclosure, the operation of determining the road boundary into which the vehicle is able to enter from the multiple road boundaries based on the ego lane where the vehicle is located includes that: the road boundary into which the vehicle is able to enter is determined from the multiple road boundaries based on the traffic signs and the ego lane where the vehicle is located.

In embodiments of the disclosure, the electronic device may identify the traffic signs in the road image in real time, and determine the road boundary into which the vehicle is able to enter from the multiple road boundaries in combination with the ego lane where the vehicle is located.

Exemplary, the traffic signs may include at least one of: one-way driving sign, right-turn traffic sign at the roundabout, no entry except in a designated direction sign, no entry sign, traffic closure sign, no vehicle crossing sign, no turning sign, pedestrian only sign, bicycle only sign, bicycle and pedestrian only sign, stop lines, lane markings, and the like.

In embodiments of the disclosure, after the electronic device determines the multiple road boundaries related to the vehicle and the ego lane where the vehicle is located, the electronic device may determines the road boundary into which the vehicle is able to enter according to the traffic signs set around the vehicle.

In other embodiments of the disclosure, the operation of determining the road boundary into which the vehicle is able to enter from the multiple road boundaries based on the ego lane where the vehicle is located includes that: position information where the vehicle is located is obtained; map sub-data related to the position information is determined from pre-obtained map data; and the road boundary into which the vehicle is able to enter is determined from the multiple road boundaries based on the map sub-data, the map data includes at least road data, road marking data and traffic signboard data.

In embodiments of the disclosure, the electronic device may pre-obtain map data, the map data may be for example data including prior information such as road information and traffic signs information. The electronic device may determine the driving direction of the vehicle according to the position information where the vehicle is located, and then determine a route that the vehicle can drive according to the position information where the vehicle is located and the driving direction of the vehicle, and determine the road boundaries into which the vehicle can enter or cannot enter according to the route that the vehicle can drive.

In some embodiments of the disclosure, the method may further include that: a driving path of the vehicle is determined based on the road boundary into which the vehicle is able to enter, and the vehicle is controlled to drive based on the driving path.

In embodiments of the disclosure, for the road boundary into which the vehicle is able to enter, the electronic device may determine the driving path of the vehicle, and the electronic device may control the vehicle to drive following the driving path.

In some embodiments of the disclosure, the method may further include that: a first region of interest is set based on the road boundary into which the vehicle is able to enter, and an image corresponding to the first region of interest is obtained at a first resolution. The road image is obtained at a second resolution, and the second resolution is smaller than the first resolution.

In other embodiments of the disclosure, the method may further include that: a second region of interest is set based on the road boundary into which the vehicle is able to enter, and an image corresponding to the second region of interest is obtained at a first frame rate. The road image is obtained at a second frame rate, and the second frame rate is smaller than the first frame rate.

In embodiments of the disclosure, the electronic device sets a region of interest (ROI) (i.e., the first region of interest and the second region of interest mentioned above) based on the road boundary into which the vehicle is able to enter. On the one hand, in the process of acquiring the road image for the road environment, the electronic device can acquire the road image at a second resolution (also referred to as a low resolution); and for the first region of interest, the electronic device can acquire an image at a first resolution (also referred to as a high resolution) higher than the second resolution, so as to acquire a higher-quality image for the first region of interest, so as to facilitate subsequent object identification for an image corresponding to the first region of interest. On the other hand, in the process of acquiring the road image for the road environment, the electronic device can acquire the road image at a second frame rate (also referred to as a low frame rate); and for the second region of interest, the electronic device can acquire an image at a first frame rate (also referred to as a high frame rate) higher than the second frame rate, so as to facilitate subsequent object identification for an image corresponding to the second region of interest.

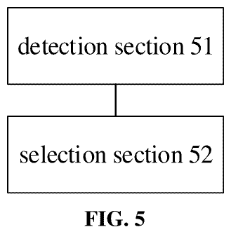

The embodiment of the disclosure further provides an apparatus for road boundary detection based on the above embodiments. FIG. 5 is a first schematic diagram of the composition structure of an apparatus for road boundary detection according to an embodiment of the disclosure. As shown in FIG. 5, the apparatus includes a detection section 51 and a selection section 52.

The detection section 51 is configured to identify a road image acquired by an image acquisition device arranged on a vehicle, and determine multiple road boundaries in the road image.

The selection section 52 is configured to select a road boundary into which the vehicle is able to enter from the multiple road boundaries.

In some embodiments of the disclosure, the selection section 52 is configured to determine ego lane where the vehicle is located based on the road image, and determine the road boundary into which the vehicle is able to enter from the multiple road boundaries based on the ego lane where the vehicle is located.

In some embodiments of the disclosure, the selection section 52 is configured to identify traffic signs in the road image, and determine the ego lane where the vehicle is located based on the traffic signs.

In other embodiments of the disclosure, the selection section 52 is configured to identify a driving direction of the other vehicle in the road image, and determine the ego lane where the vehicle is located based on the driving direction of the other vehicle.

In other embodiments of the disclosure, the selection section 52 is configured to: in a case that the traffic signs indicate that the lane where the vehicle is located is not a one-way lane, and the traffic signs comprise designated road markings, determine the ego lane where the vehicle is located based on the designated road markings.

In other embodiments of the disclosure, the selection section 52 is configured to: in a case that a driving direction of the other vehicle is opposite to a driving direction of the vehicle, determine the ego lane where the vehicle is located based on the lane where the other vehicle is located.

In some embodiments of the disclosure, the selection section 52 is configured to determine the road boundary into which the vehicle is able to enter from the multiple road boundaries based on the traffic signs and the ego lane where the vehicle is located.

In some embodiments of the disclosure, the selection section 52 is configured to obtain position information where the vehicle is located, determine map sub-data related to the position information from pre-obtained map data, and determine the road boundary into which the vehicle is able to enter from the multiple road boundaries based on the map sub-data. The map data includes at least road data, road marking data and traffic signboard data.

In some embodiments of the disclosure, the detection section 51 is configured to detect multiple lanes in the road image, and determine the multiple road boundaries related to the vehicle by connecting ends of the multiple lanes.

In some embodiments of the disclosure, the detection section 51 is configured to detect a freespace in the road image, and determine the multiple road boundaries related to the vehicle based on contour lines of the freespace.

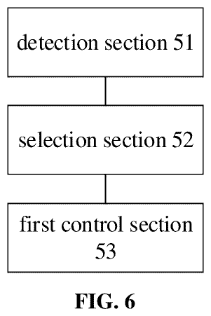

In some embodiments of the disclosure, as shown in FIG. 6, the apparatus may further include a first control section 53 configured to determine a driving path of the vehicle based on the road boundary into which the vehicle is able to enter, and control the vehicle to drive based on the driving path.

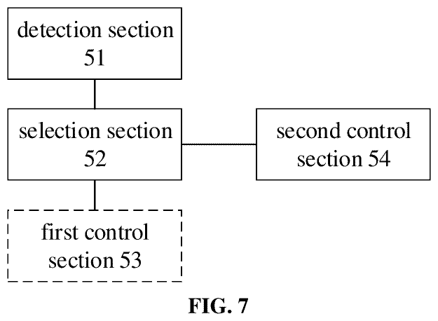

In some embodiments of the disclosure, as shown in FIG. 7, the apparatus may further include a second control section 54 configured to set a first region of interest based on the road boundary into which the vehicle is able to enter, and obtain an image corresponding to the first region of interest at a first resolution. The road image is obtained at a second resolution, and the second resolution is smaller than the first resolution.

In some embodiments of the disclosure, as shown in FIG. 7, the apparatus may further include a second control section 54 configured to set a second region of interest based on the road boundary into which the vehicle is able to enter, and obtain an image corresponding to the second region of interest at a first frame rate. The road image is obtained at a second frame rate, and the second frame rate is smaller than the first frame rate.

In an embodiment of the disclosure, the apparatus is applied to an electronic device. In practical application, the detection section 51, the selection section 52, the first control section 53, and the second control section 54 in the apparatus can be implemented by a central processing unit (CPU), a digital signal processor (DSP), a microcontroller unit (MCU), or a field-programmable gate array (FPGA).

It should be noted that the apparatus for road boundary detection provided in the above-mentioned embodiment only takes the division of the above-mentioned program modules as an example during the process of road boundary detection. In practical application, the above-mentioned process can be assigned to be completed by different program modules as needed, that is, the internal structure of the apparatus can be divided into different program modules to complete all or part of the processing described above. In addition, the apparatus for road boundary detection provided in the above-mentioned embodiments and the embodiments of the method for road boundary detection belong to the same conception, and the specific implementation process thereof is detailed in the method embodiment.

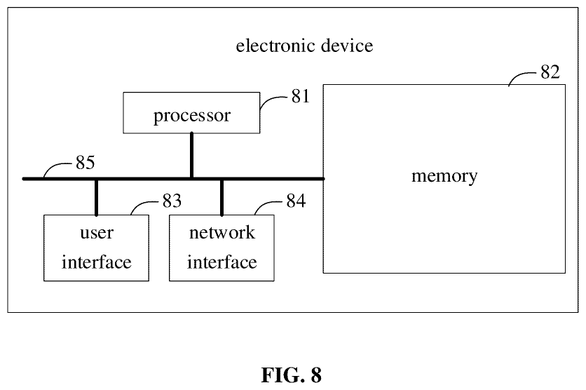

The embodiment of the disclosure also provides an electronic device. FIG. 8 is a schematic diagram of the hardware composition structure of an electronic device according to an embodiment of the disclosure. As shown in FIG. 8, the electronic device includes a memory 82, a processor 81, and a computer program stored on the memory 82 and run on the processor 81. The processor 81, when executing the program, implements operations of the method for road boundary detection described in the embodiments of the disclosure.

In some embodiments, the electronic device may further include a user interface 83 and a network interface 84. The user interface 83 may include a display, a keyboard, a mouse, a trackball, a click wheel, a key, a button, a tactile board, a touch screen, and the like.

In some embodiments, the various components in the electronic device are coupled together via a bus system 85. It is understood that the bus system 85 is configured to enable the communication connection between these components. In addition to a data bus, the bus system 85 further includes a power bus, a control bus, and a status signal bus. However, for the sake of clarity, the various buses are labeled in FIG. 8 as the bus system 85.

It is understood that the memory 82 may be a volatile memory or a non-volatile memory, or include both a volatile and a non-volatile memory. The non-volatile memory may be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disc, or a compact disc read-only memory (CD-ROM). The magnetic surface memory may be a disk memory or a magnetic tape memory. The volatile memory may be a random access memory (RAM) which serves as an external cache. By way of example but not limitation, many forms of RAMs are available, such as a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM), and a direct rambus random access memory (DRRAM). The memory 82 described in embodiments of the disclosure is intended to include but not limited to these and any other suitable types of memories.

The above method disclosed in the embodiments of the disclosure may be applied to the processor 81 or implemented by the processor 81. The processor 81 may be an integrated circuit chip with a signal processing capability. In implementation, the operations of the above methods may be accomplished by an integrated logic circuit of the hardware in the processor 81 or the instructions in the form of software. The processor 81 described above may be a general purpose processor, a DSP, or other programmable logic devices, discrete gates or transistor logic devices, discrete hardware components, and the like. The methods, operations and logic block diagrams disclosed in embodiments of the disclosure may be implemented or performed by the processor 81. The general purpose processor may be a microprocessor, or any conventional processor or the like. The operations of the methods disclosed combined with embodiments of the disclosure may be directly embodied as execution of a hardware decoding processor, or execution of a combination of a hardware and a software module in the decoding processor. The software module may be located in a storage medium, the storage medium is located in the memory 82, and the processor 81 reads information in the memory 82 and completes the operations of the method described above in combination with its hardware.

In exemplary embodiments, electronic devices may be implemented by one or more application specific integrated circuits (ASICs), DSPs, programmable logic devices (PLDs), complex programmable logic devices (CPLDs), FPGAs, general purpose processors, controllers, MCUs, microprocessors, or other electronic components for performing the foregoing methods.

In exemplary embodiments, the embodiment of the disclosure also provides a computer readable storage medium, such as the memory 82 including a computer program that is executed by the processor 81 of the electronic device to complete the operations described in the aforementioned method. The computer readable storage medium may be a memory, such as FRAM, ROM, PROM, EPROM, EEPROM, Flash Memory, magnetic surface memory, optical disc, or CD-ROM. It may also be a variety of devices including one or any combination of the above-mentioned memories.

The computer readable storage medium provided in the embodiment of the disclosure has stored thereon a computer program that, when executed by a processor, implements the operations of the method for road boundary detection described in embodiments of the disclosure.

The embodiment of the disclosure also provides a computer program product including a computer program or an instruction that, when executed on an electronic device, causes the electronic device to perform the operations of the method for road boundary detection described in embodiments of the disclosure.

The methods disclosed in several method embodiments provided in the disclosure can be arbitrarily combined without conflict to obtain new method embodiments.

The features disclosed in several product embodiments provided in the disclosure can be arbitrarily combined without conflict to obtain new product embodiments.

The features disclosed in several method embodiments or device embodiments provided in the disclosure may be arbitrarily combined without conflict to obtain new method embodiments or device embodiments.

In several embodiments provided in the disclosure, it should be understood that the disclosed devices and methods may be implemented in other ways. The device embodiments described above are schematic. For example, the division of the section is only a logical functional division, which may be implemented in another division way in practice. For example, the multiple sections or components may be combined or integrated into another system, or some features may be omitted or not implemented. In addition, coupling or direct coupling or communication connection between constituent parts shown or discussed may be indirect coupling or communication connection through some interfaces, devices or sections, and may be electrical, mechanical or other forms.

The sections described above as separate components may be or may not be physically separated, and the components displayed as sections may be or may not be physical sections, i.e. they may be located in one place or distributed across multiple network parts. Some or all of them may be selected as actual needs to achieve the purpose of the solutions in embodiments of the disclosure.

In addition, the functional sections in embodiments of the disclosure may be all integrated in one processing part, each section may be separately as one part, or two or more sections may be integrated in one part. The above-mentioned integrated part can be realized in the form of hardware, or in the form of a combination of hardware and software function sections.

Ordinary persons skilled in the art will appreciate that all or part of the operations implementing the method embodiments described above may be accomplished by hardware associated with program instructions. The program described above may be stored in a computer readable storage medium, and the program, when executed, executes the operations including the method embodiments described above. The storage medium described above includes various media capable of storing program codes, such as a mobile storage device, a ROM, a RAM, a magnetic disk or an optical disk, and the like.

Alternatively, the above-mentioned integrated part in the disclosure, when implemented in the form of a software functional module and sold or used as a stand-alone product, may also be stored in a computer readable storage medium. Based on such understanding, technical solutions in embodiments of the disclosure substantially or parts making contributions to the conventional art may be embodied in the form of a software product stored in a storage medium. The storage medium includes instructions which causes a computer device (which may be a personal computer, a server, or a network device, etc.) to execute all or part of the methods described in various embodiments of the disclosure. The storage medium described above includes various media capable of storing program codes, such as a mobile storage device, a ROM, a RAM, a magnetic disk or an optical disk, and the like.

The above description is only the specific implementation of the disclosure, however, the scope of protection of the disclosure is not limited thereto. Any variations or replacements obvious to those skilled in the art within the technical scope disclosed by the disclosure shall fall within the scope of protection of the disclosure. Therefore, the scope of protection of the disclosure should be subject to the scope of protection of the claims.

### INDUSTRIAL APPLICABILITY

Embodiments of the present disclosure provide a method and apparatus for road boundary detection, an electronic device, and a storage medium. The method includes: identifying a road image acquired by an image acquisition device arranged on a vehicle, and determining multiple road boundaries in the road image; and selecting a road boundary into which the vehicle is able to enter from the multiple road boundaries. By adopting the technical solutions of embodiments of the disclosure, the road boundary into which the vehicle is able to enter can be determined on the basis of the identified road boundaries. Especially, in the scene that the road boundaries are invisible, the determination of the road boundaries into which the vehicle is able to enter can provide sufficient basis for the decision-making of the vehicle in turning at an intersection.

1. A method for road boundary detection, performed by an electronic device, the method comprising:
identifying a road image acquired by an image acquisition device arranged on a vehicle, and determining a plurality of road boundaries in the road image; and
selecting a road boundary into which the vehicle is able to enter from the plurality of road boundaries.

2. The method of claim 1, wherein selecting the road boundary into which the vehicle is able to enter from the plurality of road boundaries, comprises:
determining an ego lane where the vehicle is located based on the road image; and
determining the road boundary into which the vehicle is able to enter from the plurality of road boundaries based on the ego lane where the vehicle is located.

3. The method of claim 2, wherein determining the ego lane where the vehicle is located based on the road image, comprises:
identifying traffic signs in the road image; and
determining the ego lane where the vehicle is located based on the traffic signs.

4. The method of claim 2, wherein determining the ego lane where the vehicle is located based on the road image, comprises:
identifying a driving direction of other vehicle in the road image; and
determining the ego lane where the vehicle is located based on the driving direction of the other vehicle.

5. The method of claim 3, wherein determining the ego lane where the vehicle is located based on the traffic signs, comprises:
in a case that the traffic signs indicate that the ego lane where the vehicle is located is not a one-way lane, and the traffic signs comprise designated road markings, determining the ego lane where the vehicle is located based on the designated road markings.

6. The method of claim 4, wherein determining the ego lane where the vehicle is located based on the driving direction of the other vehicle, comprises:
in a case that the driving direction of the other vehicle is opposite to a driving direction of the vehicle, determining the ego lane where the vehicle is located based on a lane where the other vehicle is located.

7. The method of claim 3, wherein determining the road boundary into which the vehicle is able to enter from the plurality of road boundaries based on the ego lane where the vehicle is located, comprises:
determining the road boundary into which the vehicle is able to enter from the plurality of road boundaries based on the traffic signs and the ego lane where the vehicle is located.

8. The method of claim 2, wherein determining the road boundary into which the vehicle is able to enter from the plurality of road boundaries based on the ego lane where the vehicle is located, comprises:
obtaining position information where the vehicle is located, determining map sub-data related to the position information from pre-obtained map data, and determining the road boundary into which the vehicle is able to enter from the plurality of road boundaries based on the map sub-data, the pre-obtained map data comprises at least road data, road marking data and traffic signboard data.

9. The method of claim 1, wherein determining the plurality of road boundaries in the road image, comprises:
detecting a plurality of lanes in the road image, and determining the plurality of road boundary by connecting ends of the plurality of lanes.

10. The method of claim 1, wherein determining the plurality of road boundaries in the road image, comprises:
detecting a freespace in the road image, and determining the plurality of road boundaries in the road image based on contour lines of the freespace.

11. The method of claim 1, further comprises:
determining a driving path of the vehicle based on the road boundary into which the vehicle is able to enter, and controlling the vehicle to drive based on the driving path.

12. The method of claim 1, further comprises:
setting a first region of interest based on the road boundary into which the vehicle is able to enter, and obtaining an image corresponding to the first region of interest at a first resolution;
wherein the road image is obtained at a second resolution, and the second resolution is smaller than the first resolution.

13. The method of claim 1, further comprises:
setting a second region of interest based on the road boundary into which the vehicle is able to enter, and obtaining an image corresponding to the second region of interest at a first frame rate; wherein the road image is obtained at a second frame rate, and the second frame rate is smaller than the first frame rate.

14. An apparatus for road boundary detection, comprising:
a processor, configured to:
identify a road image acquired by an image acquisition device arranged on a vehicle, and determine a plurality of road boundaries in the road image; and
select a road boundary into which the vehicle is able to enter from the plurality of road boundaries.

15. The apparatus of claim 14, wherein the processor is further configured to:
determine an ego lane where the vehicle is located based on the road image; and
determine the road boundary into which the vehicle is able to enter from the plurality of road boundaries based on the ego lane where the vehicle is located.

16. The apparatus of claim 15, wherein the processor is further configured to:
identify traffic signs in the road image; and
determine the ego lane where the vehicle is located based on the traffic signs.

17. The apparatus of claim 15, wherein the processor is further configured to:
identify a driving direction of other vehicle in the road image; and
determine the ego lane where the vehicle is located based on the driving direction of the other vehicle.

18. The apparatus of claim 16, wherein the processor is further configured to:
in a case that the traffic signs indicate that the ego lane where the vehicle is located is not a one-way lane, and the traffic signs comprise designated road markings, determine the ego lane where the vehicle is located based on the designated road markings.

19. The apparatus of claim 17, wherein the processor is further configured to:
in a case that the driving direction of the other vehicle is opposite to a driving direction of the vehicle, determine the ego lane where the vehicle is located based on a lane where the other vehicle is located.

20. A non-transitory computer readable storage medium having stored thereon a computer program that, when executed by a processor, implements a method for road boundary detection, wherein the method comprises:
identifying a road image acquired by an image acquisition device arranged on a vehicle, and determining a plurality of road boundaries in the road image; and
selecting a road boundary into which the vehicle is able to enter from the plurality of road boundaries.
